(19) United States
(12) Patent Application Publication
(10) Pub. No.: US 2007/0074497 A1
(43) Pub. Date: Apr. 5, 2007

(54) Modularized lawnmower replacement blade

(76) Inventor: Eric David Myers, Tallahassee, FL (US)

Correspondence Address: John Wiley Horton;Pennington, Moore, Wilkinson, Bell & Dunbar, P.A., 215 S. Monroe St., 2nd Floor, Tallahassee, FL, 32301, US

(21) Appl. No.: 11/601,488

(22) Filed: Nov. 17, 2006

Related U.S. Application Data
(63) Continuation-in-part of application No. 11/127,724, filed on May 12, 2005, now Pat. No. 7,155,889.

(51) Int. Cl. A01D 34/00

(52) U.S. Cl. 56/17.5; 56/295

(57) ABSTRACT

A modularized lawnower replacement blade which can be can be attached to a standard lawnmower shaft. The modularized blade includes a central disk with two recessed seats formed. between four corner wedges. A cutting blade is attached to each recessed seat so that the blades are positioned at a right-angled orientation with respect to each other.

### CROSS-REFERENCES TO RELATED APPLICATIONS

This is a continuation in part of U.S. patent application Ser. No. 11/127,724 which is currently pending and names the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of lawnmowers. More specifically, the invention comprises a modularized replacement blade which can be attached to a conventional lawnmower shaft.

2. Description of the Related Art

The overall design of the gas-powered and electric-powered lawnmower cutting system has remained unchanged in recent decades. The overall design uses an electric or gas motor to turn a shaft which extends in the direction of the ground beneath the motor. The shaft extends through a hole into the blade housing where a blade is attached to the shaft. The motor drives the shaft causing angular rotation of the blade within the housing. Grass that extends above the height of the blade is cut and discharged from the housing.

Various lawnmower replacement blades are known in the art. The designs of the replacements blades vary significantly and have been the subject of many U.S. patents. Although great efforts have been made to improve the design of replacement lawnmower blades, these designs have their shortcomings.

As an example, most commercially available blades are ineffective at neatly cutting grass when the grass is wet, tall, or thick. The rotation of a conventional blade slows down under these conditions as the lawn provides greater resistance to cutting. This resistance can often escalate as the rotation of the cutting blade continues to slow until the blade eventually stops. The escalation of resistance occurs because, as the blade slows down, the force at which the cut grass is ejected decreases. This results in the accumulation of cut grass in the housing which increases the force required to turn the blade.

Even under ideal cutting conditions, conventional blades are ineffective at “cutting” the grass. As a conventional blade begins to dull, more grass is “torn” than “cut.” As the blade strikes the grass, some of the grass is pulled by the blade until it breaks. This “tearing” of the grass results in increased cellular damage to the grass. This often causes the tip of the blade of grass to appear brown. It has also been noted that the increased cellular damage causes the grass to grow more quickly which requires more frequent mowing.

It is therefore desirable to provide a replacement lawnmower blade that is more effective at cutting grass when the grass is wet, tall, or thick. It is also desirable to provide a replacement lawnmower blade which will cut the grass without producing excessive cellular damage of the grass blades.

### BRIEF SUMMARY OF THE INVENTION

The present invention is a modularized lawnmower replacement blade which can be can be attached to a standard lawnmower shaft. The modularized blade includes a central disk with two recessed seats formed between four corner wedges. A cutting blade is attached to each recessed seat so that the blades are positioned at a right-angled orientation with respect to each other.

### BRIEF DESCRIPTION OF THE SEVERAL VIEWS OF THE DRAWINGS

FIG. 1 is a plan view, showing the present invention.

FIG. 2 is a perspective view, showing a mounting hub.

FIG. 3 is a perspective view, showing a mounting hub.

FIG. 4 is a perspective view, showing a mounting hub.

FIG. 5 is a perspective view, showing an alternate embodiment of the present invention.

FIG. 6 is a perspective view, showing an alternate embodiment of the present invention.

FIG. 7 is an exploded view, showing the present invention.

FIG. 8 is a perspective view, showing the present invention.

FIG. 9 is a section view, showing the present invention.

FIG. 10 is an exploded view, showing an alternate embodiment of the present invention.

### REFERENCE NUMERALS IN THE DRAWINGS

10 modularized replacement blade
12 cutting blade
14 mounting hub
16 bolts
18 mounting bore
20 center portion
22 corner wedge
24 bolt holes
26 recessed seat
28 side mating edge
30 back mating edge
32 bottom
34 bolt holes
36 cutting edge
38 side edge
40 back edge
42 offset
44 offset
46 recessed seat
48 recessed seat
50 cutting end
52 attaching end
54 hub
56 cutting blade
58 mounting bore
60 mounting bore
62 cutting edge
64 recessed seat
66 recessed seat
68 corner wedge
70 mating edge
72 mating edge
74 non-cutting side mating edge
76 cutting-side mating edge
78 blade housing
80 shaft
82 threaded shank
84 stop plate
86 nut
88 offset
90 offset

### DESCRIPTION OF THE INVENTION

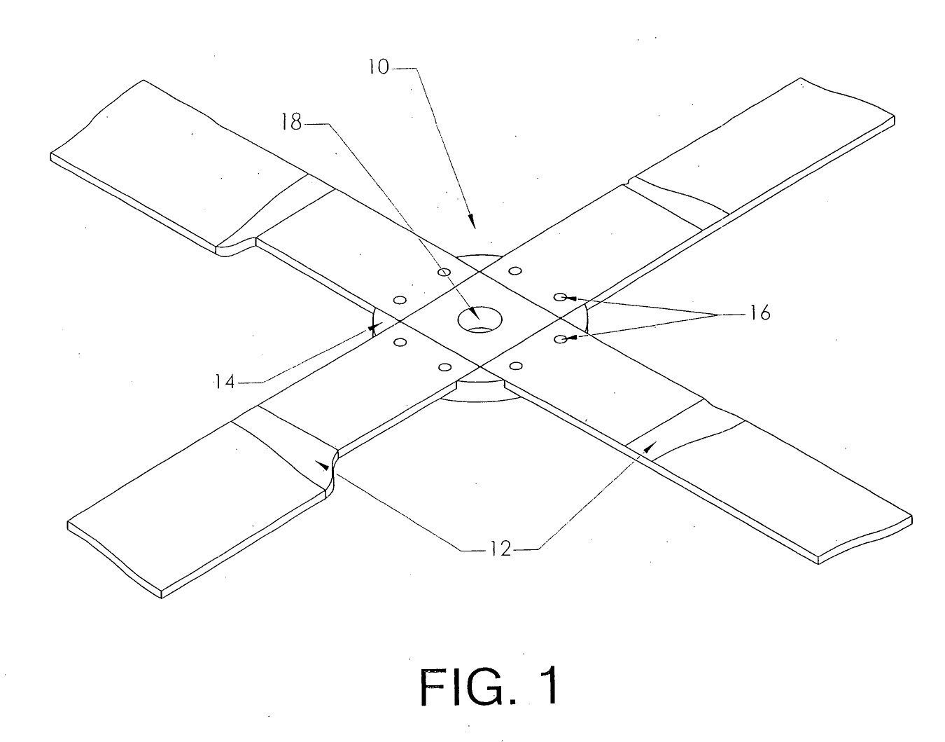

The present invention is shown in its entirety in FIG. 1. Modularized lawnmower blade 10 is generally composed of a number of cutting blades 12 (in this example, four) attached to mounting hub 14. In FIG. 1, four cutting blades 12 are illustrated at right-angled orientation with respect to each other as this arrangement represents the preferred embodiment of the invention. This configuration is believed to provide superior cutting in comparison to a single blade with two cutting edges. This is partly because the resistance provided by the lawn is spread out across twice as many cutting blades. In addition, each blade cuts approximately half as much grass as in the standard single blade mower, thus slowing the blade wear. More or fewer cutting blades 12 can be used, however, without departing from the scope or spirit of the present invention.

Mounting hub 14 has mounting bore 18 which passes from the top (side shown) to the bottom mounting hub 14. Mounting bore 18 is used to attach modularized lawnmower blade 10 to the shaft of a rotary lawnmower. Mounting bore 18 can be modified to suit all kinds of attachment features on various motor shafts. Cutting blades 12 are attached to mounting hub 14 with bolts 16.

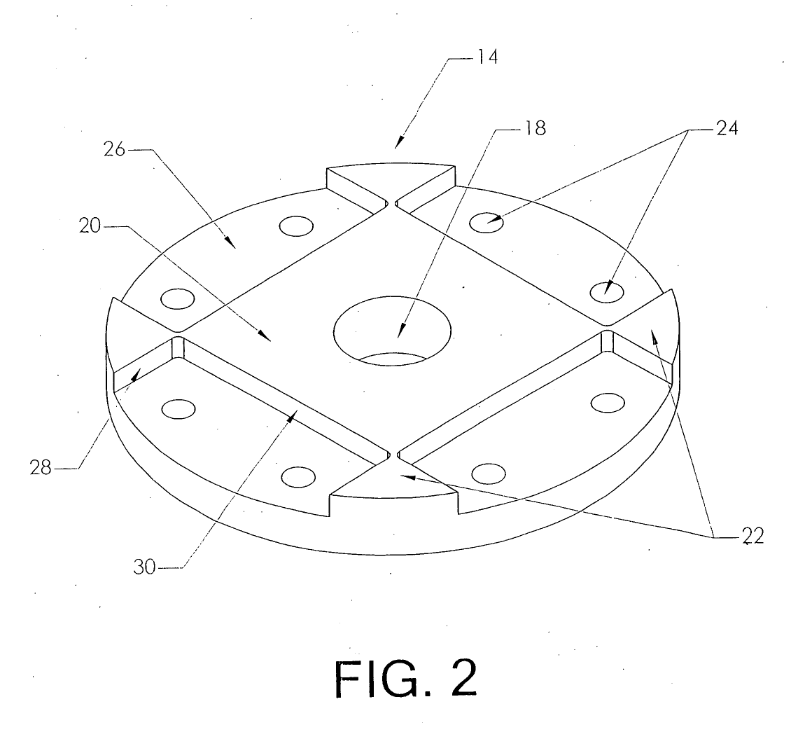

The various components of mounting hub 14 are illustrated in FIG. 2. Mounting hub 14 is preferably made of a strong metal alloy, such as steel. Mounting hub 14 has four recessed seats 26. Mounting hub 14 can also be provided with more or fewer recessed seats 26 depending on the number of blades that will be attached to mounting hub 14. Each recessed seat 26 has bolt holes 24 for attachment to cutting blade 12. Recessed seats 26 are formed by cutting out or milling the top of mounting hub 14 to form center portion 20 with corner wedges 22 at each of the corners of center portion 20 as shown. Each recessed seat 26 has a pair of side mating edges 28 where recessed seat 26 is bordered by corner wedge 22. Each recessed seat 26 also has back mating edge 30 where recessed seat 26 is bordered by center portion 20. Side mating edges 28 and back mating edge 30 serve to stabilize cutting blade 12 and prevent cutting blade 12 from shearing bolts 16 as will be described subsequently.

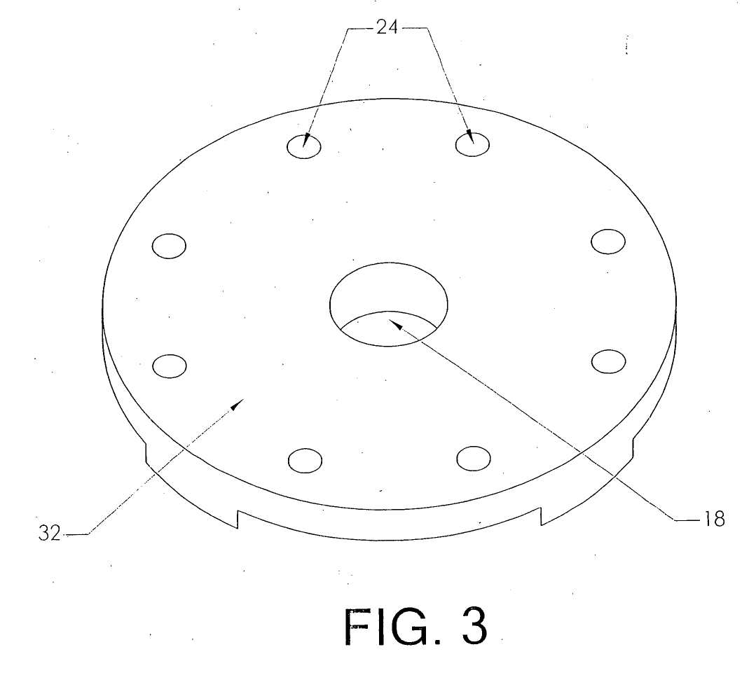

Mounting hub 14 is shown from the other side in FIG. 3. In the preferred embodiment bottom 32 is simply a flat surface except for bolt holes 24 and mounting bore 18. In the preferred embodiment bottom 32 faces the ground, but bottom 32 could also be installed facing the top of the housing of the lawnmower.

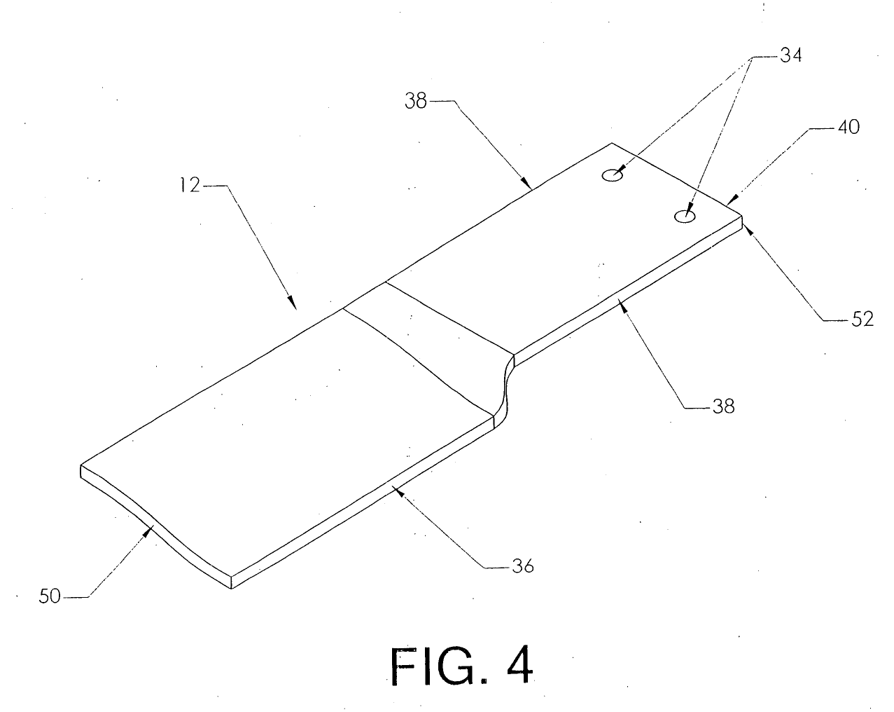

An example of cutting blade 12 is illustrated in FIG. 4. Cutting blade 12 generally has attaching end 52 and cutting end 50. Cutting blade 12 has cutting edge 36 on cutting end 50. Many types and shapes of cutting edges are known in the prior art and can be used as cutting edge 36. Attaching end 52 has bolt holes 34 which align with bolt holes 24 when the cutting blade is placed in recessed seat 26. Cutting blade 12 also has a pair of side edges 38 and back edge 40 on attaching end 52. When cutting blade 12 is attached to mounting hub 14, back edge 40 mates with back mating edge 30 and side edges 38 mate with side mating edges 28. This feature helps prevent the rotation of cutting blade 12 with respect to mounting hub 14 and ensures that cutting blades 12 are maintained in their designed orientation. In the preferred embodiment, this feature ensures that the cutting blades remain at a right-angled orientation with respect to each other. This feature also helps limit the shear stress that is delivered to the bolts when cutting blade 12 strikes a rock or other hard object.

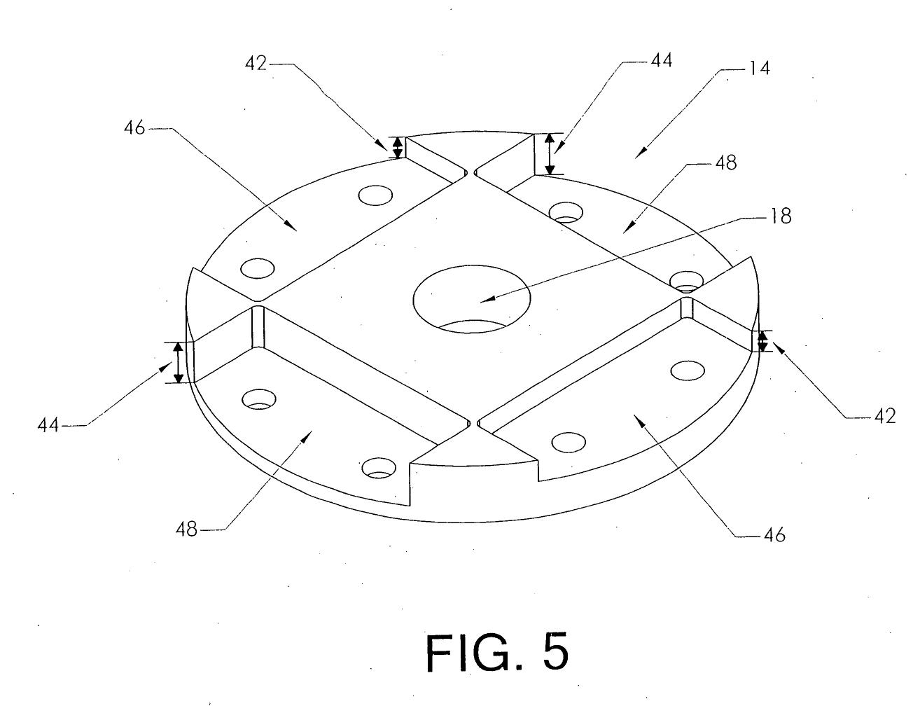

An alternate embodiment of the present invention is shown in FIG. 5. Mounting hub 14 has a pair of recessed seats 48 at a different vertical offset than pair of recessed seats 46. The viewer will appreciate that using larger offset 44 for recessed seats 48 and smaller offset 42 for recessed seats 46 results in the cutting blades being set at different heights from the ground. In this configuration, two blades effectively “precut” taller grass before it is cut by the other two blades to the final desired height. This helps prevent taller blades of grass from folding over the cutting blade and being torn away instead of being cut.

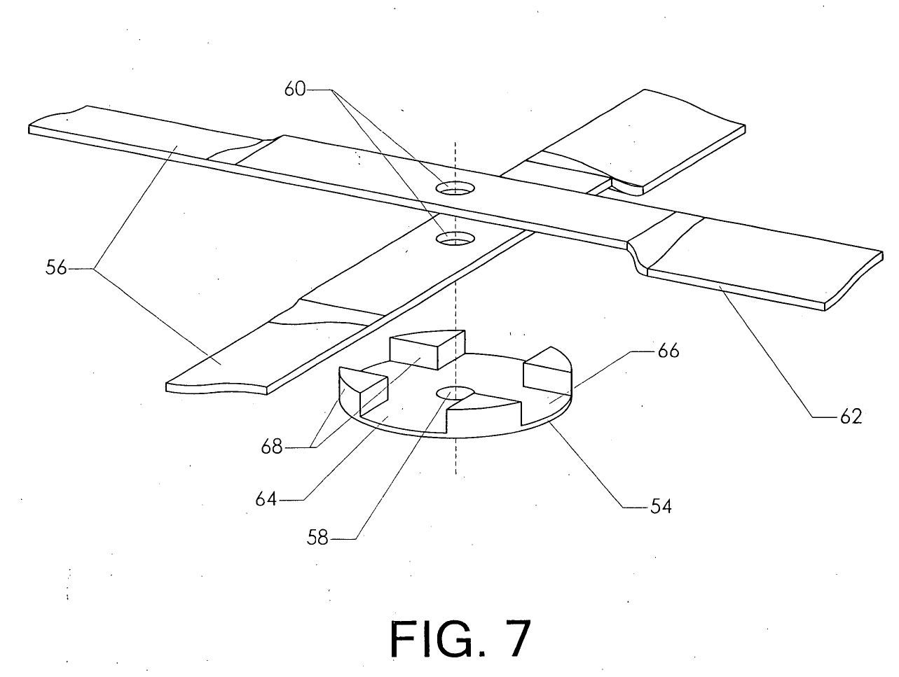

Turning now to FIG. 7, an embodiment of the present invention utilizing standard lawnmower blades is illustrated. Cutting blades 56 are standard lawnmower blades designed to fit lawnmowers of certain make and models. In the presently illustrated embodiment, cutting blades 56 are of the type and variety that are currently commercially available in stores that sell lawnmower replacement blades. Each cutting blade 56 has mounting bore 60. Mounting bore 60 is of a standardized size and fits the output shaft of most lawnmower motors. Each cutting blade 56 has a pair of cutting edges 62—one at each end of the blade. Cutting edges 62 are on opposite sides of cutting blade 56 so that both cutting edges 62 slice through the standing grass when cutting blade 56 rotates.

The pair of cutting blades 56 may be attached to a standard lawnmower blade using hub 54. Hub 54 has a top (facing upward in the present illustration), a bottom (facing downward in the present illustration), a center and a perimeter. Mounting bore 58 is provided in the center portion of hub 54. Mounting bore 58 passes through the top of hub 54 to the bottom. Mounting bore 58 is wide enough to receive the output shaft of a standard lawnmower motor.

Two recessed seats, recessed seat 64 and recessed seat 66, are formed in the top of hub 54. Each recessed seat extends from one portion of the perimeter of hub 54 to another portion of the perimeter on the opposite side of hub 54. Recessed seat 64 and recessed seat 66 are both wide enough to receive the width of cutting blades 56. In the preferred embodiment, recessed seat 64 is provided at a perpendicular orientation with respect to recessed seat 66.

Those that are skilled in the art will realize that hub 54 may be easily manufactured from a steel disk using a CNC machine. For example, recessed seat 66 and recessed seat 64 may be milled out of the top of hub 54. When recessed seats 64 and 66 are milled, four corner wedges 68 remain adjacent to and between the recessed seats. Comer wedges 68 stabilize cutting blades 56 so that cutting blades 56 remain in their normal, right-angled orientation.

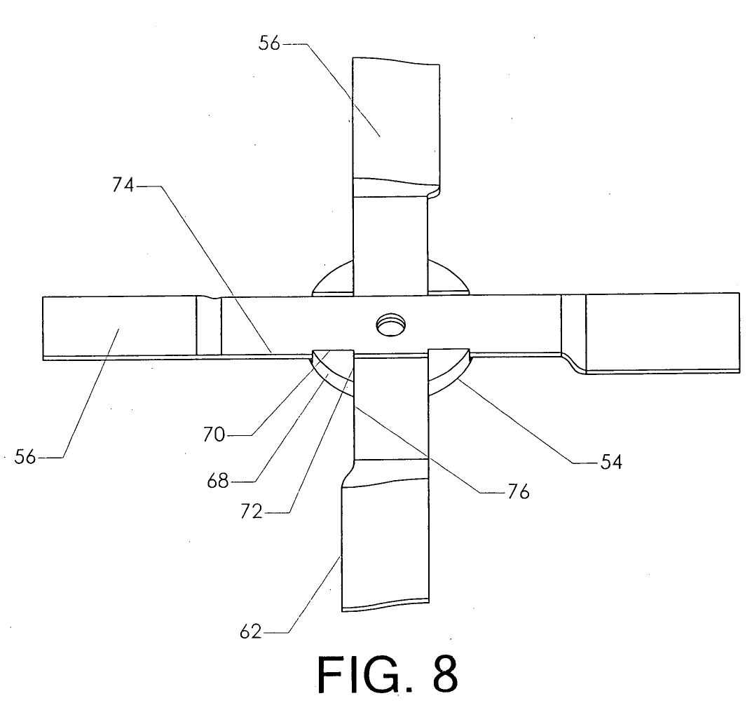

As illustrated in FIG. 8, each corner wedge 68 has mating edges 70 and 72. The mating edges are substantially perpendicular to each other. Mating edge 72 mates with cutting-side mating edge 76 of cutting blade 56. Mating edge 70 mates with non-cutting side mating edge 74 of cutting blade 56.

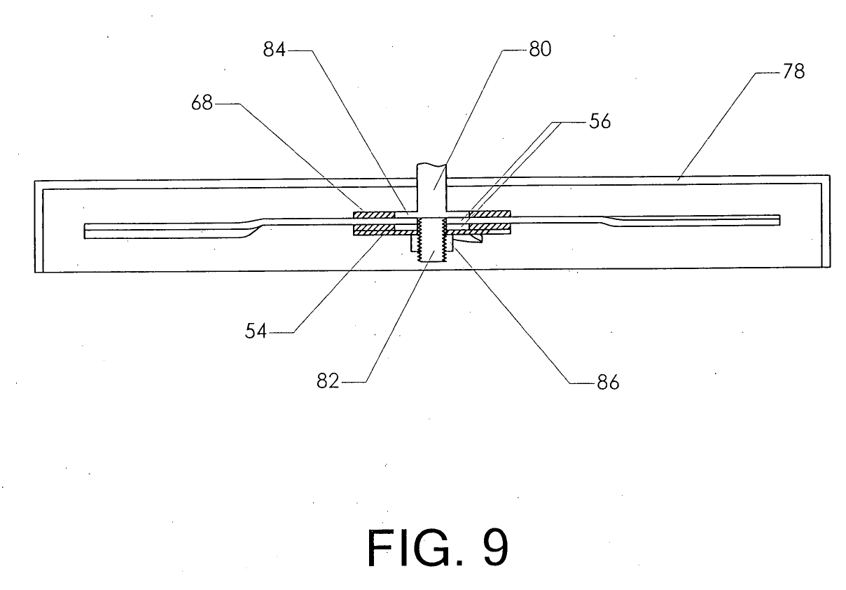

Turning now to FIG. 9, the present invention is shown attached to the output shaft of a lawnmower. Shaft 80 is the output shaft of a standard lawnmower motor. Shaft 80 extends into blade housing 78 and rotates axially when the user engages the lawnmower blade. Shaft 80 includes threaded shank 82. Stop plate 84 is provided at the top of threaded shank 82 and prevents the cutting blades from traveling up shaft 80 during operation of the mower.

Cutting blades 56 are placed in the recessed seats of hub 54 so that the mounting bores of cutting blades 56 align with the mounting bore of hub 54. Threaded shank 82 is then inserted through the assembly. Nut 86 is then threadedly attached to threaded shank 82 beneath hub 54. Nut 86 is tightened until the top cutting blade 56 mates with stop plate 84.

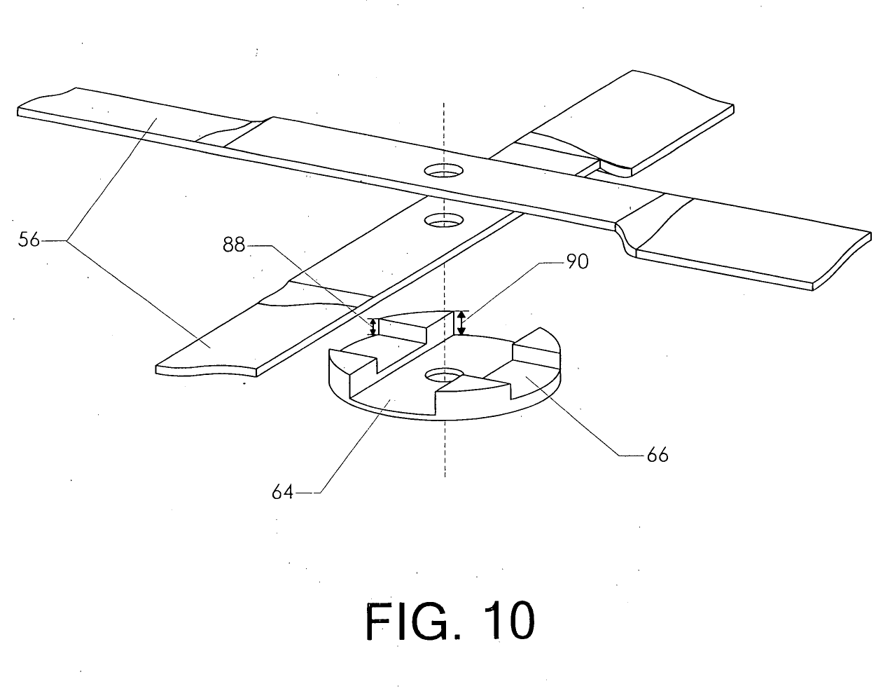

An alternate embodiment of the present invention is illustrated in FIG. 10. In this embodiment, different offsets are used for each recessed seat to provide greater blade stability. In the present illustration offset 90 of recessed seat 64 is greater than offset 88 of recessed seat 66. The use of different offsets helps prevent the top cutting blade 56 from pivoting on the bottom cutting blade 56. In the present embodiment, the top cutting blade rests on the top surface of the bottom cutting blade and the surfaces of recessed seat 66.

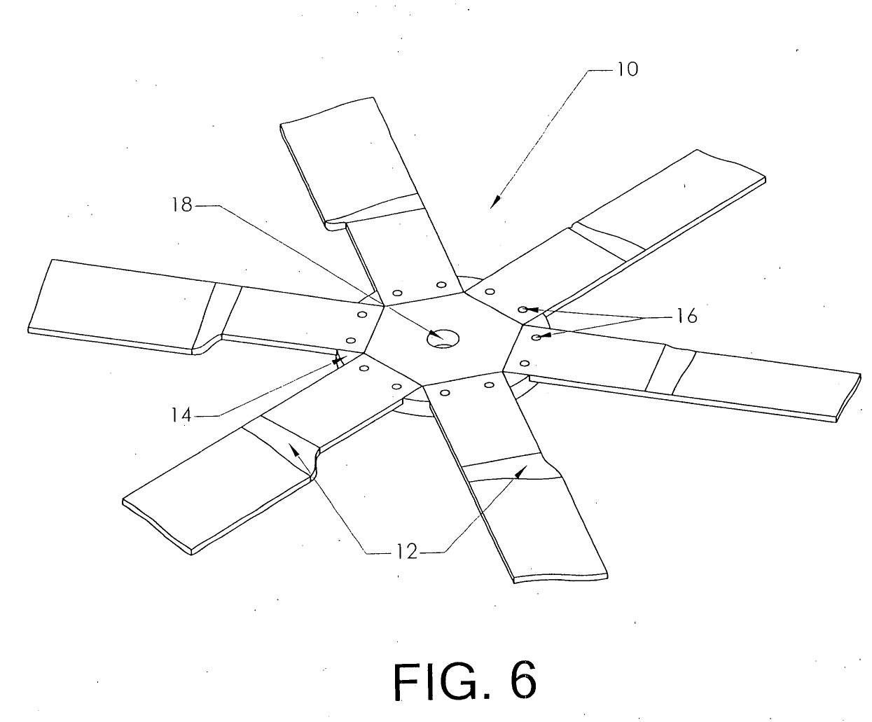

The preceding description contains significant detail regarding the novel aspects of the present invention. It should not be construed, however, as limiting the scope of the invention but rather as providing illustrations of the preferred embodiments of the invention. As an example, different quantities, types, and configuration of cutting blades 12 can be used. As shown in FIG. 6, different numbers of cutting blades can be used (in this example, six). Such variations do not alter the function of the invention. Thus, the scope of the invention should be fixed by the following claims, rather than by the examples given.

Having described my invention, I claim:

1. A modularized replacement blade for attachment to a shaft of a lawnmower, said modularized replacement blade comprising:
a. a first cutting blade, having a first cutting end, a second cutting end, and a middle portion therebetween, said first cutting blade further comprising a first side, a second side, and a width therebetween, said first cutting blade further including,
i. a first cutting edge proximal said first cutting end, said first cutting edge provided on said first side of said first cutting blade,
ii. a second cutting edge, proximal said second cutting end, said second cutting edge provided on said second side of said first cutting blade;
iii. a mounting bore provided in said middle portion configured to receive said shaft of said lawnmower;
b. a second cutting blade, having a first cutting end, a second cutting end, and a middle portion therebetween, said second cutting blade further comprising a first side, a second side, and a width therebetween, said second cutting blade further including,
i. a first cutting edge proximal said first cutting end, said first cutting edge provided on said first side of said second cutting blade,
ii. a second cutting edge, proximal said second cutting end, said second cutting edge provided on said second side of said second cutting blade;
iii. a mounting bore provided in said middle portion configured to receive said shaft of said lawnmower;
c. a mounting hub, having a top, a bottom, a center and a perimeter, said mounting hub including
i. a center portion situated on said top of said mounting hub, said center portion proximal to said center of said mounting hub;
ii. a mounting bore, said mounting bore opening through said center portion and passing from said top of said mounting hub to said bottom of said mounting hub, said mounting bore configured to receive said shaft of said lawnmower;
iii. a first recessed seat provided in said top of said mounting hub, said first recessed seat extending from a first portion of said perimeter to a second portion of said perimeter through said center portion of said mounting hub, said first recessed wide enough to receive said width of said first cutting blade;
iv. a second recessed seat provided in said top of said mounting hub, said second recessed seat extending from a third portion of said perimeter to a fourth portion of said perimeter through said center portion of said mounting hub, said second recessed wide enough to receive said width of said second cutting blade;
v. a first corner wedge situated on said top of said mounting hub, said first corner wedge proximal to said perimeter of said mounting hub and positioned adjacent to and between said first recessed seat and said second recessed seat, said first corner wedge further including a first side mating edge facing said first recessed seat and a second side mating edge facing said second recessed seat, said second side mating edge substantially perpendicular to said first side mating edge; and
vi. a second corner wedge situated on said top of said mounting hub, said second corner wedge proximal to said perimeter of said mounting hub and positioned adjacent to and between said first recessed seat and said second recessed seat, said second corner wedge further including a first side mating edge facing said first recessed seat and a second side mating edge facing said second recessed seat, said second side mating edge substantially perpendicular to said first side mating edge.

2. The modularized replacement blade of claim 1, wherein said first cutting blade is positioned in said first recessed seat so that said mounting bore of said first cutting blade aligns with said mounting bore of said mounting hub and said first side of said first cutting blade mates with said first side mating edge of said first corner wedge and said second side of said first cutting blade mates with said first side of said second corner wedge.

3. The modularized replacement blade of claim 2, wherein said second cutting blade is positioned in said second recessed seat so that said mounting bore of said second cutting blade aligns with said mounting bore of said mounting hub and said mounting bore of said first cutting blade, and said first side of said second cutting blade mates with said second side mating edge of said first corner wedge and second side mating edge of said second corner wedge.

4. The modularized replacement blade of claim 1, wherein the vertical offset of said second recessed seat is greater than the vertical offset of said first recessed seat.

5. A modularized replacement blade for attachment to a shaft of a lawnmower, said modularized replacement blade comprising:
a. a mounting hub, having a top, a bottom, a center, and a perimeter, including
i. a mounting bore, said mounting bore proximal to said center of said mounting hub and passing from said top of said mounting hub to said bottom of said mounting hub, said mounting bore configured to receive said shaft of said lawnmower;
ii. a first recessed seat provided in said top of said mounting hub, said first recessed seat extending from a first portion of said perimeter to a second portion of said perimeter through said center of said mounting hub, said first recessed wide enough to receive the width of a standard lawnmower blade;
iii. a second recessed seat provided in said top of said mounting hub, said second recessed seat extending from a third portion of said perimeter to a fourth portion of said perimeter through said center of said mounting hub, said second recessed wide enough to receive the width of a standard lawnmower blade, said first recessed seat and said second recessed seat intersecting at proximal said center of said mounting hub, said first recessed seat and said second recessed seat substantially perpendicular to each other;
iv. a first corner wedge situated on said top of said mounting hub, said first corner wedge proximal to said perimeter of said mounting hub and positioned adjacent to and between said first recessed seat and said second recessed seat, said first corner wedge further including a first side mating edge facing said first recessed seat and a second side mating edge facing said second recessed seat, said second side mating edge substantially perpendicular to said first side mating edge, said first corner wedge positioned between said first portion of said perimeter and said third portion of said perimeter; and
v. a second corner wedge situated on said top of said mounting hub, said second corner wedge proximal to said perimeter of said mounting hub and positioned adjacent to and between said first recessed seat and said second recessed seat, said second corner wedge further including a first side mating edge facing said first recessed seat and a second side mating edge facing said second recessed seat, said second side mating edge substantially perpendicular to said first side mating edge, said second corner wedge positioned between said third portion of said perimeter and said second portion of said perimeter.

6. The modularized replacement blade of claim 5, said mounting hub further comprising a third corner wedge situated on said top of said mounting hub, said third corner wedge proximal said perimeter of said mounting hub and positioned adjacent to and between said first recessed seat and said second recessed seat, said third corner wedge further including a first side mating edge facing said first recessed seat and a second side mating edge facing said second recessed seat, said second side mating edge substantially perpendicular to said first side mating edge, said third corner wedge positioned between said second portion of said perimeter and said fourth portion of said perimeter.

7. The modularized replacement blade of claim 6, said mounting hub further comprising a fourth corner wedge situated on said top of said mounting hub, said fourth corner wedge proximal said perimeter of said mounting hub and positioned adjacent to and between said first recessed seat and said second recessed seat, said fourth corner wedge further including a first side mating edge facing said first recessed seat and a second side mating edge facing said second recessed seat, said second side mating edge substantially perpendicular to said first side mating edge, said fourth corner wedge positioned between said first portion of said perimeter and said fourth portion of said perimeter.

8. The modularized replacement blade of claim 5, wherein the vertical offset of said second recessed seat is greater than the vertical offset of said first recessed seat.
